(19) United States
(12) Patent Application Publication
(10) Pub. No.: US 2004/0014357 A1
(43) Pub. Date: Jan. 22, 2004

(54) Interface connector system

(76) Inventors: John L. Madera, Renton, WA (US); Tina M. Lanfear, Hansville, WA (US)

Correspondence Address: HARNESS, DICKEY & PIERCE, P.L.C., P.O. BOX 828, BLOOMFIELD HILLS, MI, 48303, US

(21) Appl. No.: 10/454,315

(22) Filed: Jun. 4, 2003

Related U.S. Application Data
(60) Provisional application No. 60/397,334, filed on Jul. 19, 2002.

(51) Int. Cl. H01R 13/60

(52) U.S. Cl. 439/534

(57) ABSTRACT

A connector system for use adjacent a seat to allow a user seated at the seat to couple a computing device conveniently and easily, via the connector system, to a computer network. The connector system includes a main housing which houses a plurality of communications jacks as well as a plurality of power jacks. A flexible member couples the main housing to a mount assembly. The mount assembly is secured via U-shaped clamps to an existing structural member of the seat assembly. The main housing can be adjusted fore and aft relative to the mount assembly via a pair of set screws that engage the flexible member. The flexible member allows a degree of play in the event a user bumps the main housing with his or her legs while climbing into or out of the seat.

### CROSS-REFERENCE TO RELATED APPLICATIONS

This application claims priority from U.S. Ser. No. 60/397,334; filed Jul. 19, 2002.

### FIELD OF THE INVENTION

The present invention relates to interface systems used for coupling computing devices to a network, and more particularly to a connector system adapted to couple a communications cable of a portable computing device to a local area network (LAN), and where the connector system is especially well adapted for use adjacent a seat in which a user of the computing device is seated.

### BACKGROUND OF THE INVENTION

When connecting to a local area network (LAN), a computer user typically couples a communications cable from his/her computing device, typically a laptop computer, to a connector assembly. The connector assembly is in turn coupled to the network and thus the user is able to transmit and receive data, via his/her computing device, through the connector assembly.

When using a portable computing device on a mobile platform, such as an aircraft, train, bus, ship or other form of mobile vehicle having an on-board computer network, the problem of providing a convenient point for the user to couple his/her computing device exists. Ideally, the connector assembly to which the user must couple his/her computing device should be located in a position relative to a seat of the user which is comfortably accessible to the user, but which does not interfere with the use of the seat or its comfort. On mobile platforms such as commercial aircraft, the additional important consideration exists of providing a connector assembly which does not impede ingress/egress to/from the seats in the vicinity of the connector assembly. Thus, a connector assembly positioned to allow two or more users to access a LAN on the aircraft must not be positioned such that it would interfere with easy and convenient movement of passengers or crew members seated in a given row of seats adjacent the connector assembly.

Thus, there is a need for a connector system that can be easily coupled to a seat on a mobile platform, and which allows a convenient point of attachment for a user's computing device to a LAN disposed on the mobile platform without impeding movement about the seats by the users.

### SUMMARY OF THE INVENTION

The present invention is directed to a connector system particularly well adapted for use with seats on a mobile platform. The connector system includes a main housing which is coupled in a free-floating manner by a flexible member. The flexible member is in turn supported by a mount assembly. The mount assembly is coupled fixedly to a structural member of the seat. A principal advantage of the connector system is that the flexible member allows the main housing to move slightly in the event the housing is pushed or bumped by a leg of a user while using a seat adjacent to the main housing, or while moving to or from a seat adjacent to the main housing. In this manner, the flexible member provides the connector system with the inherent ability to move out of the way, to a degree, in the event an individual should bump into the main housing accidentally.

It is another important advantage of the connector system that it can be coupled to an existing structural member of a seat without expensive or complicated connection subassemblies. The mount assembly includes at least one clamp, and more preferably a pair of clamps, that couple the mount assembly to the structural member. The mount assembly includes a tubular bore which receives a portion of the flexible member. In one preferred form the flexible member comprises a tubular flexible component through which at least one communications cable extends into the main housing of the connector. The communications cable is coupled to a communications jack on the main housing which is easily accessible by a user. The flexible member can also be easily adjusted, fore to aft, by fasteners associated with the mount assembly.

In one preferred form the main housing also includes a power jack to which a user can couple a power cable to receive direct current (DC) power for powering his/her computing device. A movable cover is also employed for covering the one or more jacks of the main housing when same are not in use.

The connector system of the present invention thus forms a convenient means for allowing a user seated in a seat to access a network on a mobile platform. Advantageously, no modifications are required to the seat; the connector system can be readily coupled to an existing structural element of the seat quickly and easily and without the use of special tools or installation procedures.

Further areas of applicability of the present invention will become apparent from the detailed description provided hereinafter. It should be understood that the detailed description and specific examples are intended for purposes of illustration only and are not intended to limited the scope of the invention.

### BRIEF DESCRIPTION OF THE DRAWINGS

The present invention will become more fully understood from the detailed description and the accompanying drawings, wherein:

FIG. 1 is a perspective view of a pair of connector systems in accordance with the present invention disposed on the seats of a commercial aircraft;

FIG. 2 is a perspective view of the connector system of FIG. 2 illustrating the coupling thereof to a structural member of an aircraft seat;

FIG. 2a is a cross-sectional view of the flexible member in accordance with section line 2a-2a in FIG. 2;

FIG. 3 is an enlarged perspective view of the right most connector system shown in FIG. 1;

FIG. 4 is a view of the connector of FIG. 2 with a cover thereof in the closed position;

FIG. 5 is a perspective view of the main housing showing the spring plunger assemblies in exploded fashion;

FIG. 6 is a plan view of the main housing showing the pins used to support the cover separated from the cover and positioned in the channels on opposite sides of the main housing;

FIG. 7 is a plan view of the inside surface of the cover but without the pins used to mount the cover to the main housing; and

FIG. 8 is a perspective view of an alternative preferred form of the connector system wherein the cover is formed internally of the main housing.

### DETAILED DESCRIPTION OF THE PREFERRED EMBODIMENTS

The following description of the preferred embodiment(s) is merely exemplary in nature and is in no way intended to limit the invention, its application, or uses.

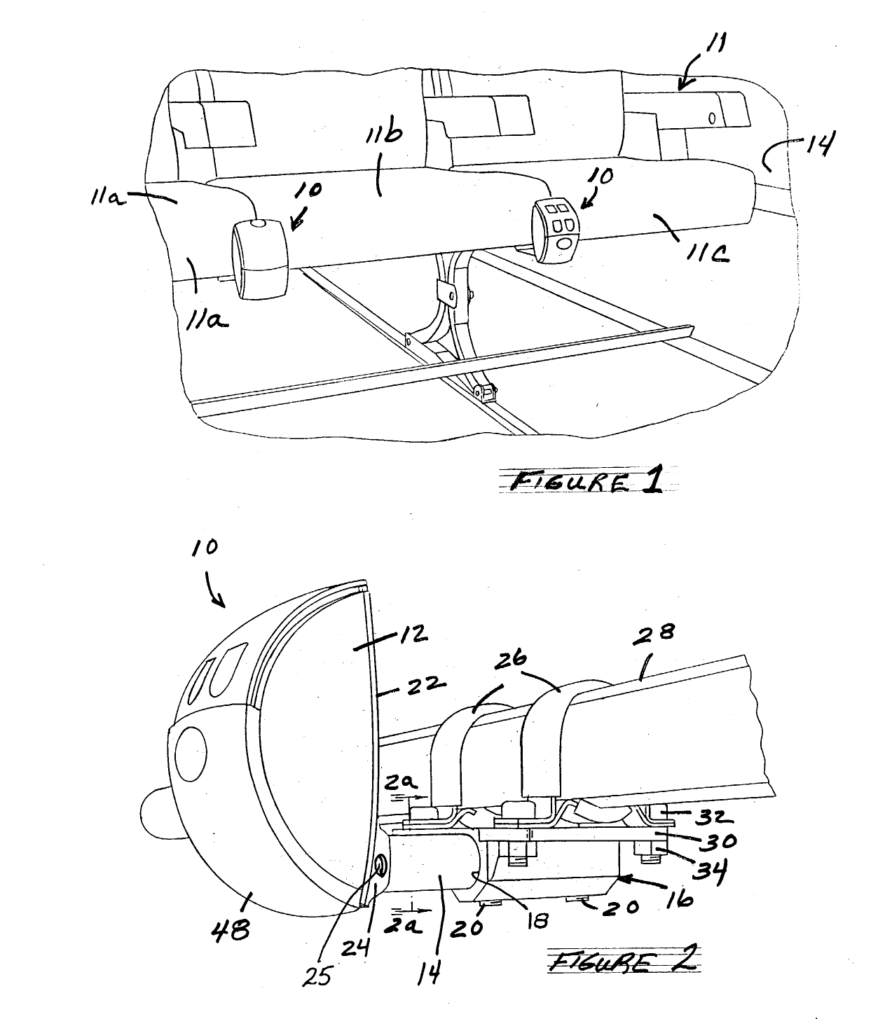

Referring to FIG. 1, there is shown a pair of connector systems 10, in accordance with a preferred embodiment of the present invention. Each connector system 10 is adapted to be secured to a seat assembly 11 within a mobile platform 14 in a manner which does not impede ingress to or egress from the independent seats 11a, 11b and 11c of the seat assembly 11. In one preferred form the connector system 10 is especially well adapted for use on a mobile platform such as a commercial aircraft. However, it will be appreciated that the connector system 10 could be incorporated just as readily on any other form of seat included on a mobile or a fixed platform. Examples of mobile platforms where the connector assembly 10 may find utility are ships, buses, trains and other forms of land vehicles, as well as in stationary environments where it would be desirable/necessary to provide a point for a user to couple his/her computing device to a computing network and to operate the computing device while seated at a seat.

Referring to FIG. 2, the connector system 10 generally comprises a main housing 12 having a rear panel 12a, a flexible coupling member 14 and a mount assembly 16. The main housing 12 is supported in a free-floating manner in view of its attachment to the flexible member 14. By “free floating” it is meant as projecting from a structure to which it is fixedly secured, but in such a manner that it is easily accessible by a user.

Flexible member 14 extends through a bore 18 in the mount assembly 16 and is held at a desired spacing away from the mount assembly 16 via a pair of set screws 20. The flexible member 14 is coupled to a rear wall 22 of the main housing 12 via a flanged portion 24 and at least one set screw 25. Coupling may also be effected by adhesives or any other mechanical fastening elements, or by a suitable clamping device. Once secured to the flexible member 14, the main housing 12 can move a small degree up and down, as well as horizontally. Thus, if a passenger or a crew member seated in one of the seats 11a, 11b, 11c of seat assembly 11 should accidentally bump into the main housing 12 while moving towards or away from one of the seats, the flexible member 14 allows a small degree of play in the positioning of the main housing 12.

With brief reference to FIG. 2a, the construction of the flexible member 14 can be seen to include an inner layer 14a and an outer flexible sleeve 14b. Inner layer 14a is comprised of two intertwined coils, one made of coil steel and the other of brass. These materials, in combination, make for a flexible tube with 360 degrees of rotational freedom. Flexible sleeve 14b is preferably comprised of a silicon material, but essentially any flexible material of suitable strength could be employed.

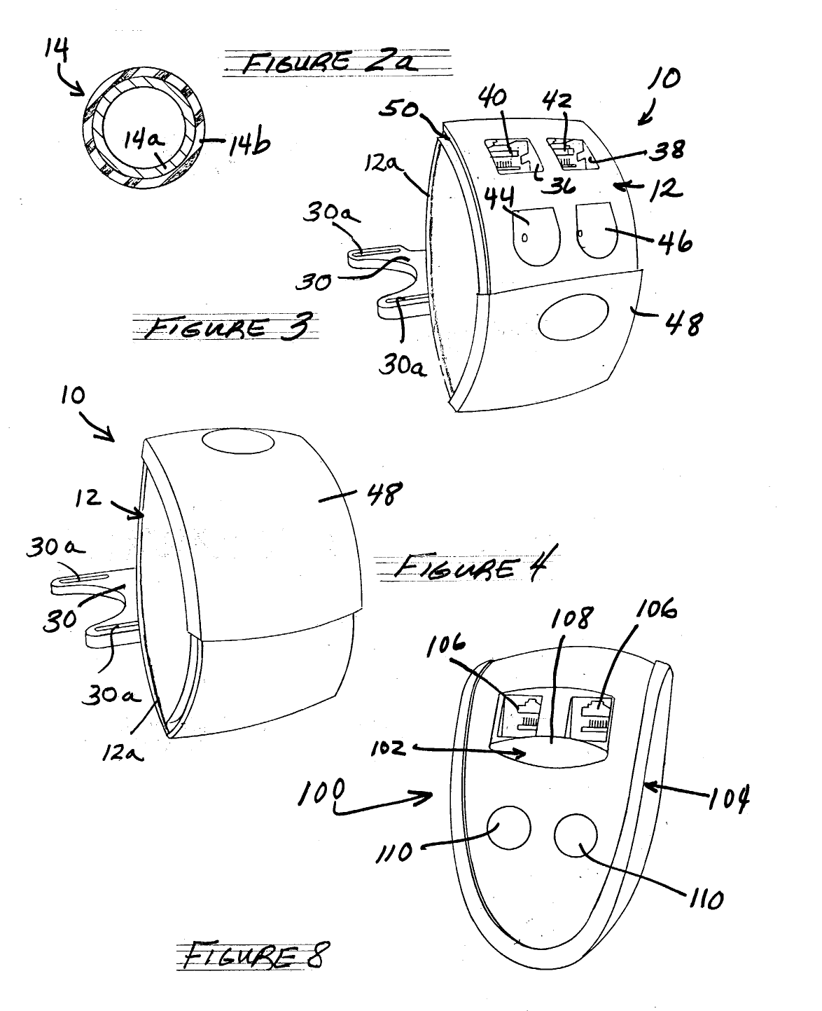

With further reference to FIGS. 2 and 3, the mount assembly 16 includes a pair of U-channel clamps 26 which are positioned over a structural member 28 of the seat assembly 11. The U-channel clamps 26 are each secured to flanges 30 of the mount assembly 16 via a plurality of threaded fasteners 32 and threaded nuts 34. Threaded fasteners 32 extend through slots 30a formed in the flanges 30 to provide a degree of lateral adjustment of the mount assembly 16. In commercial aircraft applications, no modification whatsoever is required of the seat assembly 12 before being able to attach the U-shaped clamps 26 to the flanges 30 of the mount assembly 16.

Another important feature of the connector assembly 10 is the ability to adjust the positioning of the main housing 12 fore and aft relative to the mount assembly 16. This is accomplished by use of the set screws 20 to secure the flexible member 14 such the main housing 12 is positioned at a desired position relative to a forward edge of the seats 11a, 11b and 11c (FIG. 1) of seat assembly 11.

Referring further to FIG. 3, the main housing 12 of the connector system 10 can be seen in greater detail. The main housing 12 incorporates openings 36 and 38 within which are disposed a pair of communication jacks 40 and 42, respectively. In one preferred form jacks 40 and 42 each comprise RJ-45 connectors. It will be appreciated immediately, however, that other forms of communication connectors or jacks could just as readily be employed within the main housing 12.

With continued reference to FIG. 3, the main housing 12 optionally includes a pair of direct current (DC) power jacks 44 and 46 for allowing a DC power cable to be coupled from the user's computing device to the connector system 10. In one preferred from the power jacks 44, 46 comprise ARINC 628 connectors, although virtually any type of DC power jack could be employed. While these have also been described as optional, it is anticipated that such power connector jacks will be extremely useful for individuals using a portable computing device.

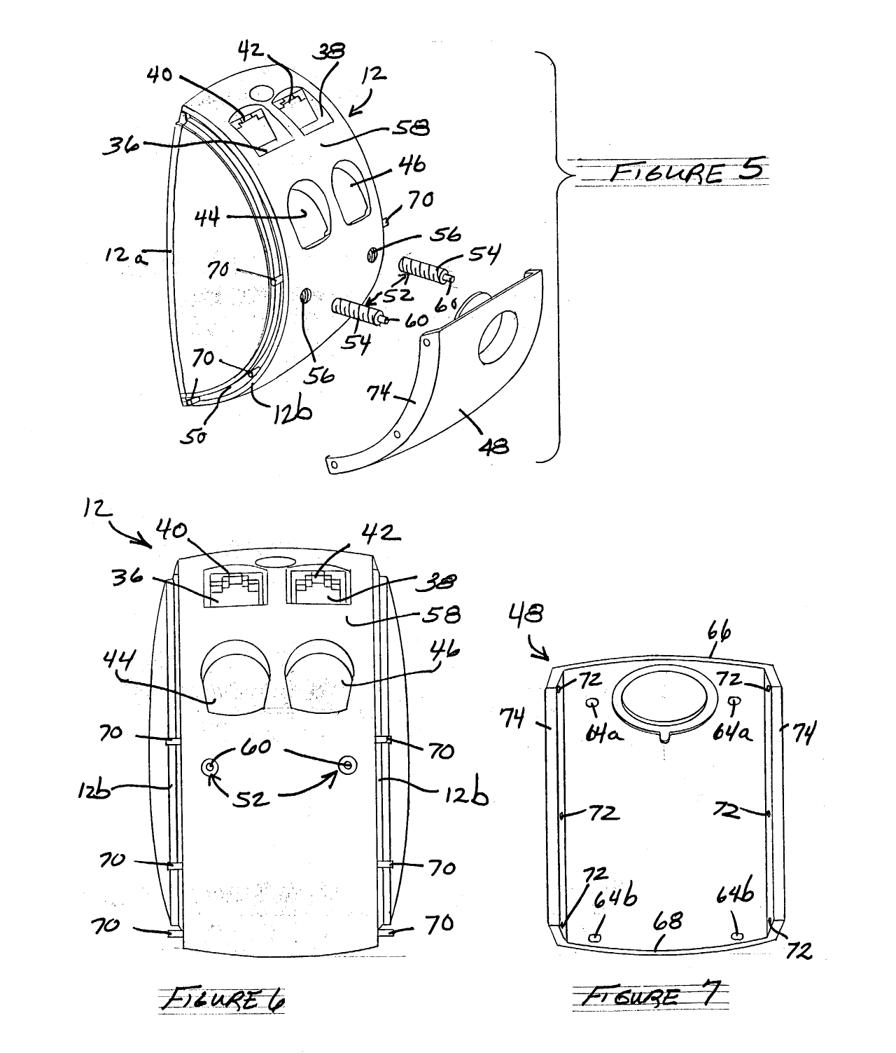

The main housing 12 further includes a movable cover 48 secured along opposing channels 50 of the main housing 12. The cover 48 is shown in FIG. 3 in its open position, wherein the communications jacks 40 and 42 and the power jacks 44 and 46 are exposed and accessible for use. The cover 48 is shown in its closed position in FIG. 4. In the closed position, none of the jacks 40, 42, 44 or 46 are accessible. The cover 48 is held in its closed position, as well as in its open position, by a pair of spring plunger assemblies 52 shown in FIGS. 5 and 6. Each of the spring plunger assemblies 52 includes a body portion 54 that is threadably inserted into a corresponding threaded aperture 56 in a front surface 58 of the main housing 12. A spring biased plunger 60 protrudes form the body portion 54. The spring plunger assemblies 52 are commercially available as “Vlier” spring plungers through Barry Controls of Brighton, Mass. The assemblies 52 are further adjustable because the plunger 60 can be rotated to adjust the degree it protrudes from its associated body portion 54. It will be appreciated, however, that a wide variety of other forms of spring biased components could just as readily be implemented to perform the function of holding the cover 48 in either its open or its closed position.

Referring briefly to FIG. 7, the cover 48 includes an inside surface 62 having a plurality of detents 64a-64b. The detents 64 are arranged in spaced apart pairs near opposite longitudinal edges of the front surface of the main housing 12. Detent pair 64a is arranged near upper edge 66 of the cover 48. Detent pair 64b is arranged near a lower edge 68. Detent pair 64a engages with the plunger 60 of each of the spring plunger assemblies 52 to hold the cover 48 in the open position (FIG. 3). Detents 64b engage with the plungers 60 when the cover is raised into the closed position (FIG. 4) to hold the cover in the closed position.

With further reference to FIG. 5, the main housing 12 further can be seen to include a plurality of guide pins 70 that are press fit into the cover 48 to protrude outwardly and generally parallel to the front surface 58 from the channels 50 (FIG. 3) on each side of the main housing 12. The guide pins 70 are press fit into openings 72 formed in flanges 74 on opposite sides edges of the cover 48 (see also FIG. 7) to retain the cover 48 to the main housing 12. The guide pins 70 allow sliding movement of the cover 48 between the open and closed positions as they ride within channels 50 formed on opposite side portions 12b of the main housing 12. The guide pins 70 may be formed from any suitably strong material but in one preferred form comprise polished stainless steel pins having a Teflon® coating. The channels 76 are closed off at their outermost ends by the rear cover 12a when the rear cover is installed (either by a snap fit arrangement or by adhesives) to help form the main housing 12.

FIG. 8 illustrates an alternative preferred connector system 100 of the present invention which is substantially identical to connector system 10, with the exception of an internally mounted cover 102 disposed within a main housing portion 104 of the connector 100. The internal connector 102 is adapted to cover a pair of RJ-45 communication jacks 106 and includes a manually graspable edge portion 108 for manipulating the cover 102 between its open and closed positions.

With further reference to FIG. 8, the connector system 100 similarly optionally includes a pair of DC power jacks 110. The cover 102 is also preferably spring biased such that it is held in a closed position covering jacks 106 when the jacks are not in use.

The present invention thus forms a convenient, relatively inexpensive connector assembly which can be readily secured to existing seat structures used in commercial aircraft. The present invention is not limited to commercial aircraft in its application, but is anticipated to find utility in a wide variety of other mobile platforms, as well as with fixed platforms. Essentially, with any application where a computer connection port needs to be placed adjacent a user's seat, the present invention can be employed to provide a point of convenient attachment for a user's computing device. Also, while reference has been made throughout the foregoing text of a “computing device”, it will be appreciated that this reference is meant to encompass not only a laptop computer, but also a personal digital assistant (PDA), a LCD display screen or any other form of information/data computing and/or display device that could be used with an electronic communications cable.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A connector system for coupling a computing device to a network, said system comprising:
a main housing:
at least one communications jack disposed in said main housing for coupling with a communications cable associated with said computing device;
a mount adapted to be fixedly secured to a structural member from which said connector system is being supported; and
a flexible member coupled intermediate said mount and said main housing for supporting said main housing in a free floating manner from said mount assembly.

2. The system of claim 1, wherein said main housing further comprises:
a power jack for supplying direct current (DC) power to said computing device.

3. The system of claim 1, wherein said main housing further comprises:
a cover moveable between an open position, wherein said communications is accessible for use, and a closed position, wherein said communications jack is covered by said cover and inaccessible for use.

4. The system of claim 3, further comprising a spring for biasing and maintaining said cover in said closed position.

5. The system of claim 1, wherein said flexible member comprises a flexible tubular member.

6. The system of claim 1, wherein:
said mount comprises a bore; and
said flexible member comprises a flexible tubular member having one distal end thereof secured within said bore.

7. The system of claim 5, wherein said flexible tubular member comprises:
a pair of intertwined coils forming a flexible tube; and
a flexible sleeve disposed over said flexible tube.

8. The system of claim 7, wherein said intertwined coils comprise steel and brass coils.

9. A connector system adapted for use with a seat for coupling a computing device being used by a user seated in said seat to a communications cable, said system comprising:
a main housing:
at least one communications jack disposed in said main housing for coupling with a communications cable associated with said computing device;
a mount adapted to be fixedly secured to a structural member associated with said seat from which said connector system is being supported;
a flexible, tubular member coupled at a first end to said main housing and at a second end to said mount for supporting said main housing in a free floating manner from said mount assembly.

10. The system of claim 9, wherein said main housing further comprises:
a power jack for coupling with a power cable associated with said computing device.

11. The system of claim 9, wherein said main housing further comprises a cover for covering said communications jack.

12. The system of claim 11, further comprising a spring for biasing said cover from an open position, wherein said communications jack is accessible for use, to a closed position, wherein said communications jack is covered by said cover.

13. A connector system adapted for use with a seat for coupling a computing device being used by a user seated in said seat to a communications cable, said system comprising:
a main housing:
at least one communications jack disposed in said main housing for coupling with a communications cable associated with said computing device;
at least one power jack disposed in said main housing and adapted for coupling with a direct current (DC) power cable associated with said computing device;
a mount adapted to be fixedly secured to a structural member associated with said seat from which said connector system is being supported; and
a flexible, tubular member coupled at a first end to said main housing and at a second end to said mount for supporting said main housing in a free floating manner from said mount.

14. The system of claim 13, further comprising a cover coupled to said main housing for covering said communications jack and said DC power jack.

15. The system of claim 14, further comprising a spring for biasing said cover from an open position, wherein said communications jack and said DC power jack are accessible for use, to a closed position, wherein said communications jack and said DC power jack are covered by said cover.
